SEQUENCE LISTING (1 sequence)

SEQ ID NO: 1 - protein, 39 aa, Artificial Sequence
  Synthetic
SPPPAGSSPGGNKLWEIFLRVAEEEMQKSLDSTFTGEGH

(19) United States
(12) Patent Application Publication
(10) Pub. No.: US 2015/0297450 A1
(43) Pub. Date: Oct. 22, 2015

(54) Light-Protective Cover for a Container

(71) Applicant: Sanofi-Aventis Deutschland GmbH, Frankfurt am Main (DE)

(72) Inventor: Sebastian Thiel, Frankfurt am Main (DE)

(73) Assignee: Sanofi-Aventis Deutschland GmbH, Frankfurt am Main (DE)

(21) Appl. No.: 14/403,955

(22) PCT Filed: May 29, 2013
(86) PCT No.: PCT/EP2013/061060

§ 371 Date: Nov. 25, 2014

(30) Foreign Application Priority Data
Jun. 1, 2012 (EP) 12170382.1

(51) Int. Cl. A61J 1/14; B65B 11/00; B65D 81/30

(52) U.S. Cl. CPC A61J 1/1468; B65D 81/30; B65B 11/004

(57) ABSTRACT

The present invention relates to a light-protective cover for a container (50; 80) accommodating a light-sensitive substance, the cover comprising: a bottom face (16; 36; 66) with at least one trough opening (14; 34; 64) to receive a port structure (54; 86) of the container (50; 80), a sidewall (18; 38; 68) integrally formed with the bottom face (16; 36; 66) and being adapted to at least partially enclose the container (50; 80), wherein the sidewall (18; 38; 68) and/or the bottom face (16; 36; 66) are made of a mechanically stretchable material being substantially opaque for electromagnetic radiation of a predefined spectral range.

### CROSS REFERENCE TO RELATED APPLICATIONS

The present application is a U.S. National Phase Application pursuant to 35 U.S.C. §371 of International Application No. PCT/EP2013/061060 filed May 29, 2013, which claims priority to European Patent Application No. 12170382.1 filed Jun. 1, 2012. The entire disclosure contents of these applications are herewith incorporated by reference into the present application.

### FIELD OF INVENTION

The present invention relates to a light-protective cover for a container adapted to accommodate and/or to store a light-sensitive substance such like a medicament.

### BACKGROUND

Light-sensitive substances should be either kept and stored in a dimmed environment or should be effectively protected against electromagnetic radiation. When exposed to electromagnetic radiation of a specific spectral range or wave length, such light-sensitive substances may be susceptible to a mechanical or photo-chemical reaction, typically resulting in degradation of the substance.

Providing the light-sensitive substance in an opaque container may be not adequate for a variety of medical applications. Opaque containers may not be universally applicable with light-sensitive medicaments since a visual inspection of the medicament may be generally required prior to administer the medicament to a patient.

Document WO 01/56895 A2 discloses a light-protective container assembly comprising a translucent container defining an inner reservoir to contain a fluid and having a flexible sleeve connected to the container, wherein the sleeve is made of a material capable of substantially preventing the transmission of an identified range of wavelength of the electromagnetic spectrum. The sleeve is particularly designed for a flexible intravenous bag and is formed of a first sidewall and a second sidewall each having opposite lateral edge portions which can be bonded or sealed together to define a tubular structure to receive the flexible bag.

Moreover, the sleeve may be indirectly connected to the container by including at least one passageway through the container. The sleeve is then positioned on the container with one portion on one side of the container and with another portion on an opposite side of the container. First and second portions of the sleeve are then attached together, such as by a heat stake or a fastening through the passageway of the container.

By irreleasably connecting the sleeve to the container, repeated use of the sleeve with a plurality of containers is generally not possible. Moreover, visual inspection of the container disposed inside the sleeve requires that the sleeve has an opened lower end to allow the sleeve to be displaced relative to the container. Since the lower end of the sleeve is open, the sleeve cannot provide a fastening of the container, e.g. to an infusion stand.

### SUMMARY

It is therefore an object of the present invention to provide an improved light-protective cover for a container to accommodate a light-sensitive substance. The light-protective cover should be easy manageable in terms of assembly and disassembly and should be universally adaptable to a large variety of containers featuring different size, geometry and mechanical constitution. The light-protective cover should be equally applicable to rigid containers, such like bottles, ampoules or cartridges as well as to rather soft and elastic bags. Additionally, the cover should be repeatedly usable with a series of containers.

In a first aspect, the invention provides a light-protective cover for a container, wherein the container is adapted to accommodate or to receive a light-sensitive substance, in particular a liquid medicament. The cover comprises a bottom face with at least one through opening to receive a port structure of the container. Furthermore, the cover comprises a sidewall being integrally formed with the bottom face and being adapted to at least partially enclose the container. The sidewall and/or the bottom face are made of a mechanically stretchable material being substantially opaque for electromagnetic radiation of a predefined spectral range.

By providing the sidewall and/or the bottom face as a dilatable, tensile, stretchable or ductile structure, the light-protective cover can be individually and universally adapted and customized to a large variety of differently sized containers. The stretchable tensile or ductile material, the sidewall and/or the bottom face is made of, allows to wrap or to enclose the container with the light-protective cover in a firm fitting way. Since the light-protective cover comprises a bottom face, it may provide a support structure for the container to be disposed therein. The bottom face of the light-protective cover is substantially closed and comprises a comparatively small through opening which is adapted to receive a port structure, which is either to be connected with the container or which belongs to the same.

The material the sidewall and/or the bottom face of the light-protective cover are made of comprises a tensile modulus of 0.01 to 0.1 kN/mm² or even less. Typically, the sidewall and bottom face are made from the same material or material mixture, and may be manufactured by way of extruding.

Typically, the initial dimensions of the bottom face and/or the sidewall and in particular the diameter or the inner cross section of the light-protective cover is at least slightly smaller than the respective outer dimensions of the container. In this way, the cover will always be elastically stretched while or when assembled to the container.

In an embodiment, the bottom face comprises a circular, oval or rectangular shape while the sidewall extends substantially parallel to a surface normal of the bottom face at least when the cover is in an extended configuration. Typically, the bottom face is rather planar or even shaped but may also comprise an axially inwardly or outwardly bulged geometry. The light-protective cover typically comprises a substantially tubular geometry, wherein the sidewall surrounds the bottom face and merges with lateral borders thereof. This way, the bottom face and the sidewall form a hollow tubular structure adapted to receive the container.

In a further embodiment the sidewall is unrollable or unfoldable from a curled initial configuration into an extended configuration, in which the sidewall comprises a substantially seamless tubular structure. By manufacturing the sidewall and the bottom face as a single-pieced extruded foil-like protective cover, the sidewall can be provided substantially seamless allowing to curl and to roll up the sidewall into a curled initial configuration.

In such a curled configuration, the light-protective cover can be stored and separately distributed in a space-saving way with a comparatively high package density. The curled initial configuration of the light-protective cover is particularly advantageous for wrapping the container in the light-protective cover. In its curled initial configuration, the sidewall substantially shrinks to an annular-shaped bulged portion across which its bottom face extends. For wrapping the container into the light-protective cover, an end face of the container, typically a dispensing end thereof can be brought in abutment with the bottom face of the cover.

Moreover, in an initial configuration and prior to an assembly to the container, the sidewall may be curled to form an annular or ring shaped bulged portion. The elasticity and dimension, in particular the thickness of the material the light-protective cover is made of, allows to curl up the sidewall into an annular bulged portion having a thickness or axial extension being substantially smaller than the inner diameter of the sidewall when unrolled. Typically, the diameter of the bulged portion, hence the axial or radial thickness thereof is smaller than 30%, 20%, 10% or even smaller than 5% of the inner diameter of the annular ring formed by the curled sidewall.

Thereafter, the curled sidewall can be unrolled or unfurled in an axial direction, thereby tightly enclosing a sidewall of the container. After or during use of the container, the sidewall can be at least partially curled or rolled up again in order to uncover a portion of the container and/or to remove the light-protective cover there from.

By unfurling or unfolding the curled light-protective cover, a tight fitting light-protective arrangement for a container can be provided. It is particular due to the stretchable and ductile properties of the cover and due to the tight fitting of the light-protective cover to the container, that the cover can be used for a variety of differently sized and shaped medicament containers. The cover is not only suitable for infusion bags or bottles but may also be applied to injection cartridges that need to be assembled in a drug delivery device such like an infusion pump.

The present light-protective cover therefore has only a negligible impact on the outer geometry of the container and may therefore serve as a kind of opaque and removable coating.

In another embodiment, the sidewall of the light-protective cover comprises a free end facing away from the bottom face. This free end, which is located opposite to the bottom face forms an opening adapted to receive the container. In its curled configuration, the annular-shaped curled sidewall comprises an inner diameter that substantially matches the inner diameter of the opening. Typically, the maximum stretched axial extension of the sidewall is substantially larger than the axial dimensions of the container to be wrapped in the light-protective cover. Therefore, the opening provided at an upper end of the sidewall does not have to be closed. The free end of the sidewall may therefore effectively overlap the upper end of the container, thereby effectively inhibiting its exposure to light.

In particular, the axial extension of the sidewall may by far exceed the axial extension of the container. In this way, the substantially cylindrically shaped free end of the light-protective cover will be located at a predefined and comparatively large distance from a respective end section of the container. As a consequence, the end of the container facing away from the port structure can be entirely enclosed by the sidewall of the cover extending beyond the end of the container in axial direction. Consequently, oppositely located sections of the free end of the sidewall can be brought in contact with each other to effectively close the light-protective cover. A radially inwardly extending flange, to surround an upper of the container and which may hinder the unrolling of the sidewall, is neither required nor intended.

In a further embodiment, the sidewall of the light-protective cover comprises at least one lateral through opening which is arranged at a predetermined distance from the free end of the sidewall in order to provide a hanger structure. The sidewall may even comprise two diametrically opposed through openings which substantially overlap when respective sidewall portions get in mutual contact.

Typically, the through openings are provided in an upper portion of the sidewall which extends between the free end of the sidewall and an upper end of the container enclosed therein. The at least one through opening of the sidewall may serve as a hanger hole allowing to hang the light-protective cover to a hook, e.g. of an infusion stand. Since the bottom face of the light-protective cover is substantially closed apart from the through opening for the port structure, the light-protective cover may also serve to hang the container disposed therein to an infusion stand. This way, the container itself does no longer require an own and separate hanger structure.

By means of the stretchable material enclosing the container, the container can be frictionally engaged with the light-protective cover, which in turn is adapted to be fastened to a hook or the like. Infusion bags or bottles to be arranged in a hanging configuration do therefore no longer have to be provided with a fastening or hanging structure. By simply wrapping the light-protective cover around the respective container, a hanger or fastening structure can be effectively provided in a simple and reliable way.

According to another embodiment, the free end of the sidewall and/or of the at least one through opening of the sidewall comprise a reinforcing structure. The reinforcing structure may comprise a different material compared to the material the sidewall is made of. Additionally, the reinforcing structure may comprise a seam provided by thermally treating the edges of the through opening and/or of the free end of the sidewall.

By providing the free end and/or the through opening with a reinforcing structure, the light-protective cover is less susceptible to rupture and mechanical damage.

In a further embodiment, the bottom face and/or the sidewall at least in sections comprises at least one undulated structure. Also, the entire sidewall and/or the entire bottom face may comprise a plurality of undulated structures, which may be equidistantly arranged in order to provide geometric stretching in either radial and/or axial direction if required.

The undulations or undulated structures may extend substantially parallel to each other in axial and/or in circumferential direction with respect to the overall tubular geometry of the light-protective cover. The undulations or undulated structure may either be provided across the entire sidewall or bottom face but may also be provided only on selected portions or areas thereof.

According to another embodiment, the material, the bottom face and/or the sidewall are made or are selected from: synthetic rubber, butyl rubber, silicone, polyethylene, polyurethane and/or combinations thereof. The material, the bottom face and/or the sidewall are made of is typically doped with a dye or with pigments which either absorbs and/or reflect electromagnetic radiation of a predefined spectral range.

Here, the type of pigments or dyes as well as their concentration, e.g. in a batch mixture of the cover material, is selected and adapted in accordance with the type of substance to be stored in the container. Moreover, concentration of the pigments or dyes in the material may be adapted according to the intended degree of stretching or dilatation of the sidewall. The concentration of the dye or pigments has to be selected such, that even a maximum dilated or stretched sidewall still comprises an opacity above a minimum required degree.

In another but independent aspect, the invention also relates to a container assembly comprising at least one container being at least partially filled with a light-sensitive substance. The container assembly further comprises a light-protective cover as described above, which is at least partially wrapped around the container. The container may comprise a flexible infusion bag made of a polymeric material, such like polyethylene. Alternatively, the container may also comprise a vitreous body, e.g. made of glass. Typically, the container is substantially translucent and allows for visual inspection of the liquid substance contained therein.

It is only by way of wrapping, especially by way of unfurling or unfolding the sidewall of the light-protective cover along respective sidewall sections of the container, that the inner volume of the container can be protected against electromagnetic radiation of a predefined spectral range.

In a further embodiment, the container is filled with a liquid medicament.

In still another aspect, the invention also relates to a method of wrapping a container, which container is adapted to accommodate or to receive a light-sensitive substance. The method of wrapping said container comprises the steps of arranging a curled light-protective cover near a discharge end of the container. Thereafter, the bottom face of the light-protective cover is brought in close proximity or in direct abutment with an end face of the container. Thereafter, the curled sidewall of the light-protective cover is unrolled or unfurled to at least partially wrap and to protect the container against electromagnetic radiation.

Upon demand, the light-protective cover can be at least partially furled in order to allow visual inspection at least of a portion of the container. Moreover, after the content of the container has used up, the light-protective cover can be furled and can be repeatedly unrolled or unfurled on another container. The curling and furling of the sidewall of the light-protective cover therefore provides an intuitive and easy approach on how to wrap and unwrap a container with a light-protective cover.

Moreover, by curling or furling the sidewall and by separating the light-protective cover and the container after use, the two entities can be discarded or recycled separately in an environmentally friendly way.

The term “drug” or “medicament”, as used herein, means a pharmaceutical formulation containing at least one pharmaceutically active compound,

wherein in one embodiment the pharmaceutically active compound has a molecular weight up to 1500 Da and/or is a peptide, a proteine, a polysaccharide, a vaccine, a DNA, a RNA, an enzyme, an antibody or a fragment thereof, a hormone or an oligonucleotide, or a mixture of the above-mentioned pharmaceutically active compound,

wherein in a further embodiment the pharmaceutically active compound is useful for the treatment and/or prophylaxis of diabetes mellitus or complications associated with diabetes mellitus such as diabetic retinopathy, thromboembolism disorders such as deep vein or pulmonary thromboembolism, acute coronary syndrome (ACS), angina, myocardial infarction, cancer, macular degeneration, inflammation, hay fever, atherosclerosis and/or rheumatoid arthritis,

wherein in a further embodiment the pharmaceutically active compound comprises at least one peptide for the treatment and/or prophylaxis of diabetes mellitus or complications associated with diabetes mellitus such as diabetic retinopathy,

wherein in a further embodiment the pharmaceutically active compound comprises at least one human insulin or a human insulin analogue or derivative, glucagon-like peptide (GLP-1) or an analogue or derivative thereof, or exendin-3 or exendin-4 or an analogue or derivative of exendin-3 or exendin-4.

Insulin analogues are for example Gly(A21), Arg(B31), Arg(B32) human insulin; Lys(B3), Glu(B29) human insulin; Lys(B28), Pro(B29) human insulin; Asp(B28) human insulin; human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Insulin derivates are for example B29-N-myristoyl-des(B30) human insulin; B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N—(N-palmitoyl-Y-glutamyl)-des(B30) human insulin; B29-N—(N-lithocholyl-Y-glutamyl)-des(B30) human insulin; B29-N-(ω-carboxyheptadecanoyl)-des(B30) human insulin and B29-N-(ω-carboxyheptadecanoyl) human insulin.

Exendin-4 for example means Exendin-4(1-39), a peptide of the sequence H-His-Gly-Glu-Gly-Thr-Phe-Thr-Ser-Asp-Leu-Ser-Lys-Gln-Met-Glu-Glu-Glu-Ala-Val-Arg-Leu-Phe-Ile-Glu-Trp-Leu-Lys-Asn-Gly-Gly-Pro-Ser-Ser-Gly-Ala-Pro-Pro-Pro-Ser-NH2.

Exendin-4 derivatives are for example selected from the following list of compounds:

H-(Lys)4-des Pro36, des Pro37 Exendin-4(1-39)-NH2,

H-(Lys)5-des Pro36, des Pro37 Exendin-4(1-39)-NH2,

des Pro36 Exendin-4(1-39),des Pro36 [Asp28] Exendin-4(1-39),

des Pro36 [IsoAsp28] Exendin-4(1-39),

des Pro36 [Met(O)14, Asp28] Exendin-4(1-39),

des Pro36 [Met(O)14, IsoAsp28] Exendin-4(1-39),

des Pro36 [Trp(O2)25, Asp28] Exendin-4(1-39),

des Pro36 [Trp(O2)25, IsoAsp28] Exendin-4(1-39),

des Pro36 [Met(O)14 Trp(O2)25, Asp28] Exendin-4(1-39),

des Pro36 [Met(O)14 Trp(O2)25, IsoAsp28] Exendin-4(1-39); or

des Pro36 [Asp28] Exendin-4(1-39),

des Pro36 [IsoAsp28] Exendin-4(1-39),

des Pro36 [Met(O)14, Asp28] Exendin-4(1-39),

des Pro36 [Met(O)14, IsoAsp28] Exendin-4(1-39),

des Pro36 [Trp(O2)25, Asp28] Exendin-4(1-39),

des Pro36 [Trp(O2)25, IsoAsp28] Exendin-4(1-39),

des Pro36 [Met(O)14 Trp(O2)25, Asp28] Exendin-4(1-39),

des Pro36 [Met(O)14 Trp(O2)25, IsoAsp28] Exendin-4(1-39),

wherein the group -Lys6-NH2 may be bound to the C-terminus of the Exendin-4 derivative;

or an Exendin-4 derivative of the sequence

des Pro36 Exendin-4(1-39)-Lys6-NH2 (AVE0010),

H-(Lys)6-des Pro36 [Asp28] Exendin-4(1-39)-Lys6-NH2,

des Asp28 Pro36, Pro37, Pro38Exendin-4(1-39)-NH2,

H-(Lys)6-des Pro36, Pro38 [Asp28] Exendin-4(1-39)-NH2,

H-Asn-(Glu)5des Pro36, Pro37, Pro38 [Asp28] Exendin-4(1-39)-NH2,

des Pro36, Pro37, Pro38 [Asp28] Exendin-4(1-39)-(Lys)6-NH2,

H-(Lys)6-des Pro36, Pro37, Pro38 [Asp28] Exendin-4(1-39)-(Lys)6-NH2,

H-Asn-(Glu)5-des Pro36, Pro37, Pro38 [Asp28] Exendin-4(1-39)-(Lys)6-NH2,

H-(Lys)6-des Pro36 [Trp(O2)25, Asp28] Exendin-4(1-39)-Lys6-NH2,

H-des Asp28 Pro36, Pro37, Pro38 [Trp(O2)25] Exendin-4(1-39)-NH2,

H-(Lys)6-des Pro36, Pro37, Pro38 [Trp(O2)25, Asp28] Exendin-4(1-39)-NH2,

H-Asn-(Glu)5-des Pro36, Pro37, Pro38 [Trp(O2)25, Asp28] Exendin-4(1-39)-NH2,

des Pro36, Pro37, Pro38 [Trp(O2)25, Asp28] Exendin-4(1-39)-(Lys)6-NH2,

H-(Lys)6-des Pro36, Pro37, Pro38 [Trp(O2)25, Asp28] Exendin-4(1-39)-(Lys)6-NH2,

H-Asn-(Glu)5-des Pro36, Pro37, Pro38 [Trp(O2)25, Asp28] Exendin-4(1-39)-(Lys)6-NH2,

H-(Lys)6-des Pro36 [Met(O)14, Asp28] Exendin-4(1-39)-Lys6-NH2,

des Met(O)14 Asp28 Pro36, Pro37, Pro38 Exendin-4(1-39)-NH2,

H-(Lys)6-desPro36, Pro37, Pro38 [Met(O)14, Asp28] Exendin-4(1-39)-NH2,

H-Asn-(Glu)5-des Pro36, Pro37, Pro38 [Met(O)14, Asp28] Exendin-4(1-39)-NH2,

des Pro36, Pro37, Pro38 [Met(O)14, Asp28] Exendin-4(1-39)-(Lys)6-NH2,

H-(Lys)6-des Pro36, Pro37, Pro38 [Met(O)14, Asp28] Exendin-4(1-39)-(Lys)6-NH2,

H-Asn-(Glu)5 des Pro36, Pro37, Pro38 [Met(O)14, Asp28] Exendin-4(1-39)-(Lys)6-NH2,

H-Lys6-des Pro36 [Met(O)14, Trp(O2)25, Asp28] Exendin-4(1-39)-Lys6-NH2,

H-des Asp28 Pro36, Pro37, Pro38 [Met(O)14, Trp(O2)25] Exendin-4(1-39)-NH2,

H-(Lys)6-des Pro36, Pro37, Pro38 [Met(O)14, Asp28] Exendin-4(1-39)-NH2,

H-Asn-(Glu)5-des Pro36, Pro37, Pro38 [Met(O)14, Trp(O2)25, Asp28] Exendin-4(1-39)-NH2,

des Pro36, Pro37, Pro38 [Met(O)14, Trp(O2)25, Asp28] Exendin-4(1-39)-(Lys)6-NH2,

H-(Lys)6-des Pro36, Pro37, Pro38 [Met(O)14, Trp(O2)25, Asp28] Exendin-4(S1-39)-(Lys)6-NH2,

H-Asn-(Glu)5-des Pro36, Pro37, Pro38 [Met(O)14, Trp(O2)25, Asp28] Exendin-4(1-39)-(Lys)6-NH2;

or a pharmaceutically acceptable salt or solvate of any one of the afore-mentioned Exendin-4 derivative.

Hormones are for example hypophysis hormones or hypothalamus hormones or regulatory active peptides and their antagonists as listed in Rote Liste, ed. 2008, Chapter 50, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, Goserelin.

A polysaccharide is for example a glucosaminoglycane, a hyaluronic acid, a heparin, a low molecular weight heparin or an ultra low molecular weight heparin or a derivative thereof, or a sulphated, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium.

Antibodies are globular plasma proteins (˜150 kDa) that are also known as immunoglobulins which share a basic structure. As they have sugar chains added to amino acid residues, they are glycoproteins. The basic functional unit of each antibody is an immunoglobulin (Ig) monomer (containing only one Ig unit); secreted antibodies can also be dimeric with two Ig units as with IgA, tetrameric with four Ig units like teleost fish IgM, or pentameric with five Ig units, like mammalian IgM.

The Ig monomer is a “Y”-shaped molecule that consists of four polypeptide chains; two identical heavy chains and two identical light chains connected by disulfide bonds between cysteine residues. Each heavy chain is about 440 amino acids long; each light chain is about 220 amino acids long. Heavy and light chains each contain intrachain disulfide bonds which stabilize their folding. Each chain is composed of structural domains called Ig domains. These domains contain about 70-110 amino acids and are classified into different categories (for example, variable or V, and constant or C) according to their size and function. They have a characteristic immunoglobulin fold in which two β sheets create a “sandwich” shape, held together by interactions between conserved cysteines and other charged amino acids.

There are five types of mammalian Ig heavy chain denoted by α, δ, ε, γ, and μ. The type of heavy chain present defines the isotype of antibody; these chains are found in IgA, IgD, IgE, IgG, and IgM antibodies, respectively.

Distinct heavy chains differ in size and composition; α and γ contain approximately 450 amino acids and δ approximately 500 amino acids, while μ and ε have approximately 550 amino acids. Each heavy chain has two regions, the constant region (C_{H}) and the variable region (V_{H}). In one species, the constant region is essentially identical in all antibodies of the same isotype, but differs in antibodies of different isotypes. Heavy chains γ, α and δ have a constant region composed of three tandem Ig domains, and a hinge region for added flexibility; heavy chains μ and ε have a constant region composed of four immunoglobulin domains. The variable region of the heavy chain differs in antibodies produced by different B cells, but is the same for all antibodies produced by a single B cell or B cell clone. The variable region of each heavy chain is approximately 110 amino acids long and is composed of a single Ig domain.

In mammals, there are two types of immunoglobulin light chain denoted by λ and κ. A light chain has two successive domains: one constant domain (CL) and one variable domain (VL). The approximate length of a light chain is 211 to 217 amino acids. Each antibody contains two light chains that are always identical; only one type of light chain, κ or λ, is present per antibody in mammals.

Although the general structure of all antibodies is very similar, the unique property of a given antibody is determined by the variable (V) regions, as detailed above. More specifically, variable loops, three each the light (VL) and three on the heavy (VH) chain, are responsible for binding to the antigen, i.e. for its antigen specificity. These loops are referred to as the Complementarity Determining Regions (CDRs). Because CDRs from both VH and VL domains contribute to the antigen-binding site, it is the combination of the heavy and the light chains, and not either alone, that determines the final antigen specificity.

An “antibody fragment” contains at least one antigen binding fragment as defined above, and exhibits essentially the same function and specificity as the complete antibody of which the fragment is derived from. Limited proteolytic digestion with papain cleaves the Ig prototype into three fragments. Two identical amino terminal fragments, each containing one entire L chain and about half an H chain, are the antigen binding fragments (Fab). The third fragment, similar in size but containing the carboxyl terminal half of both heavy chains with their interchain disulfide bond, is the crystalizable fragment (Fc). The Fc contains carbohydrates, complement-binding, and FcR-binding sites. Limited pepsin digestion yields a single F(ab′)2 fragment containing both Fab pieces and the hinge region, including the H—H interchain disulfide bond. F(ab′)2 is divalent for antigen binding. The disulfide bond of F(ab′)2 may be cleaved in order to obtain Fab′. Moreover, the variable regions of the heavy and light chains can be fused together to form a single chain variable fragment (scFv).

Pharmaceutically acceptable salts are for example acid addition salts and basic salts. Acid addition salts are e.g. HCl or HBr salts. Basic salts are e.g. salts having a cation selected from alkali or alkaline, e.g. Na+, or K+, or Ca2+, or an ammonium ion N+(R1)(R2)(R3)(R4), wherein R1 to R4 independently of each other mean: hydrogen, an optionally substituted C1-C6-alkyl group, an optionally substituted C2-C6-alkenyl group, an optionally substituted C6-C10-aryl group, or an optionally substituted C6-C10-heteroaryl group. Further examples of pharmaceutically acceptable salts are described in “Remington's Pharmaceutical Sciences” 17. ed. Alfonso R. Gennaro (Ed.), Mark Publishing Company, Easton, Pa., U.S.A., 1985 and in Encyclopedia of Pharmaceutical Technology.

Pharmaceutically acceptable solvates are for example hydrates.

It is to be noted, that all features and embodiments as described herein are to be understood to equally apply to the cover and the method of its use. In particular, a mentioning of a component being configured or arranged to conduct a particular operation is to be understood to disclose a respective method and vice versa.

It will be further apparent to those skilled in the pertinent art that various modifications and variations can be made to the present invention without departing from the spirit and scope of the invention. Further, it is to be noted, that any reference signs used in the appended claims are not to be construed as limiting the scope of the present invention.

### BRIEF DESCRIPTION OF THE DRAWINGS

In the following, various embodiments of the invention will be described by making reference to the figures, in which:

FIG. 1 schematically illustrates a first embodiment of the light-protective cover in a curled initial configuration as seen from the side,

FIG. 2 shows the light-protective cover according to FIG. 1 from the top,

FIG. 3 shows another embodiment of the light-protective cover comprising a substantially oval shape,

FIG. 4 shows the light-protective cover according to FIGS. 1 and 2 in an unfurled or unrolled elongated configuration,

FIG. 5 shows a container assembly comprising a syringe as a container for a medicament being partially wrapped in the light-protective cover,

FIG. 6 shows the container assembly according to FIG. 5 with an unrolled cover,

FIG. 7 shows another embodiment of a light-protective cover having a perforation near its free end,

FIG. 8 shows an unfurled configuration of a light-protective cover with a through opening near its free end,

FIG. 9 shows another container assembly with a flexible infusion bag disposed inside a light-protective cover according to FIG. 7 or 8,

FIG. 10 shows the container assembly according to FIG. 9 in a hanging configuration,

FIG. 11 shows a light-protective cover with an undulated sidewall in a perspective illustration and

FIG. 12 shows the light-protective cover according to FIG. 11 in cross-section.

### DETAILED DESCRIPTION

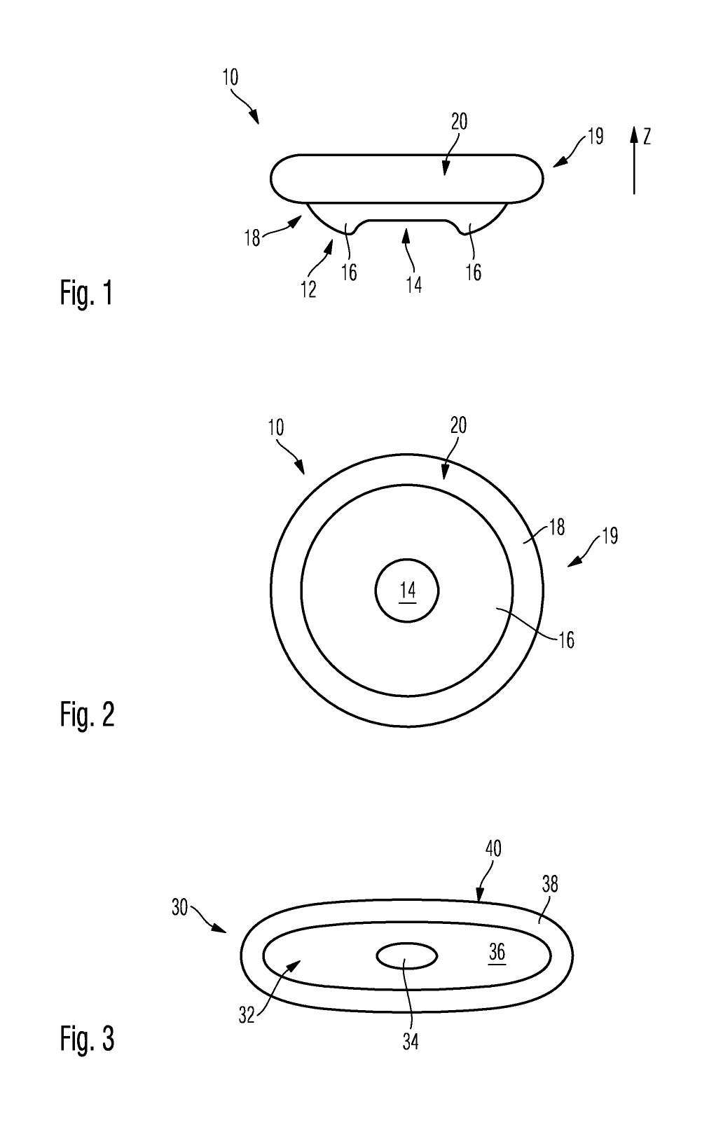

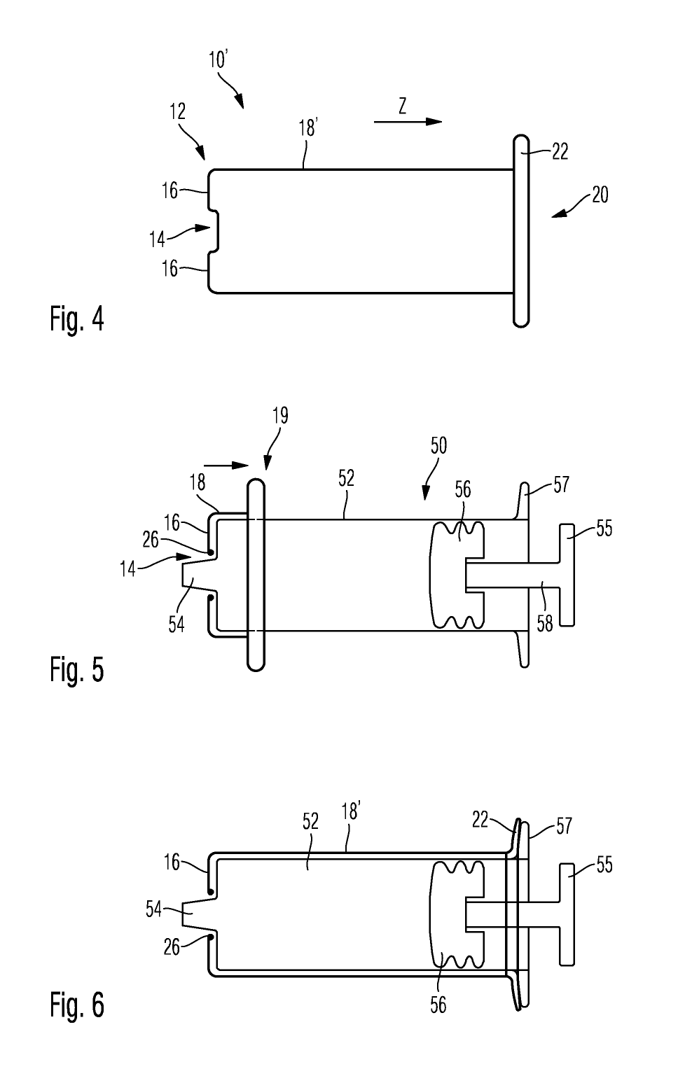

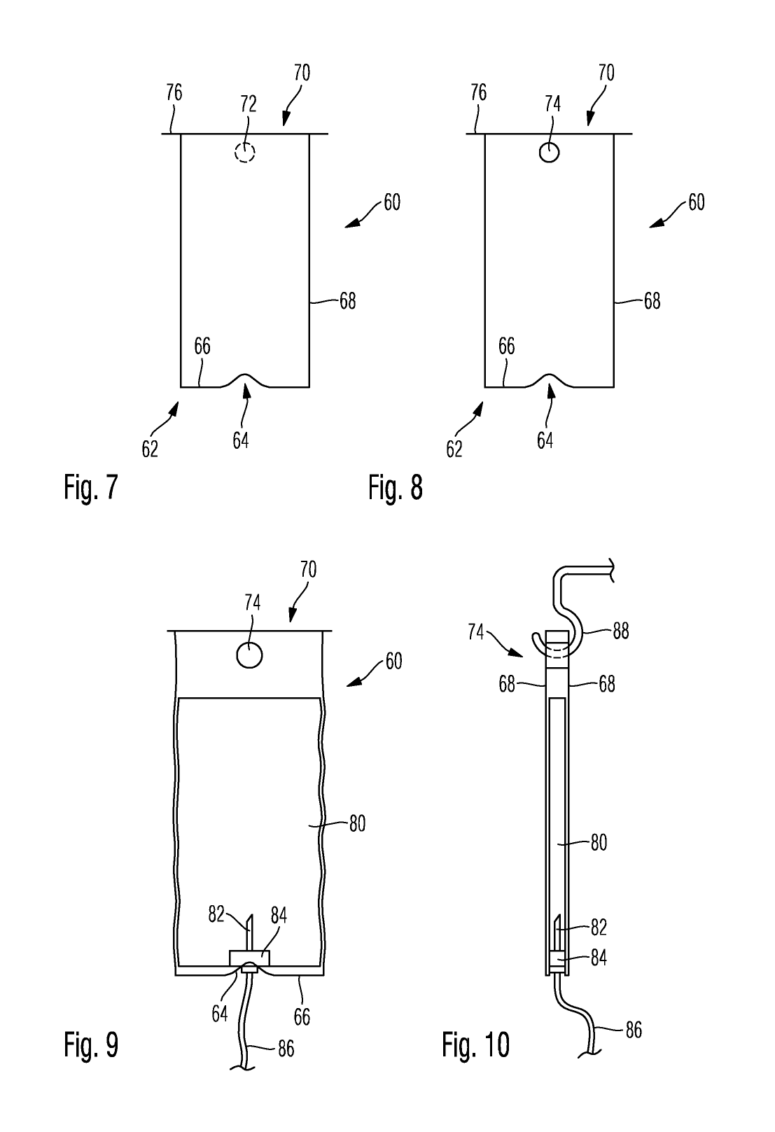

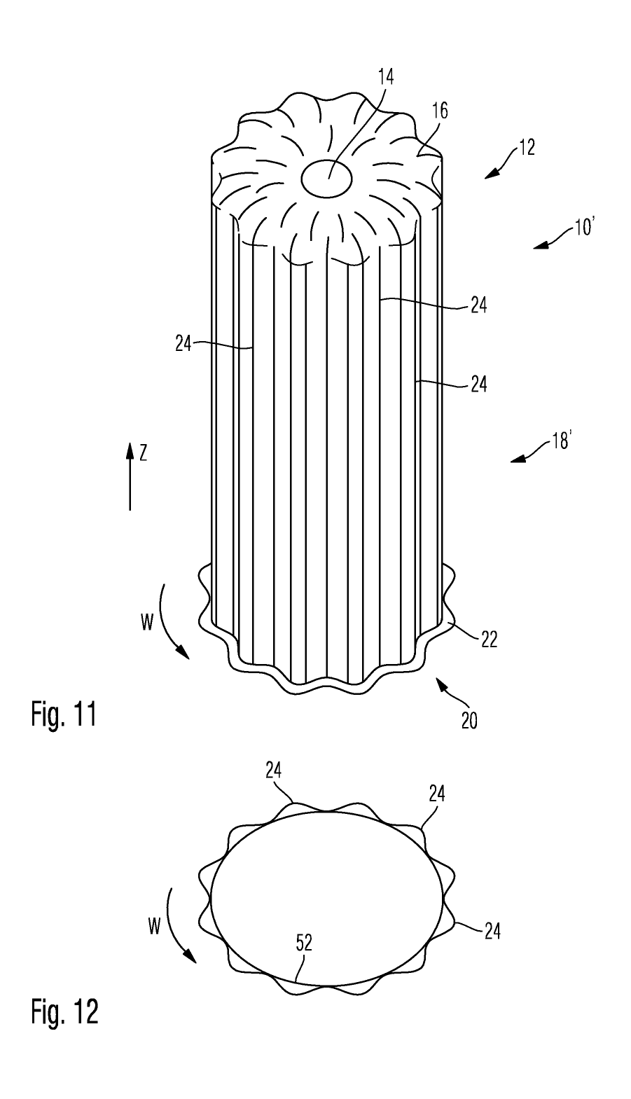

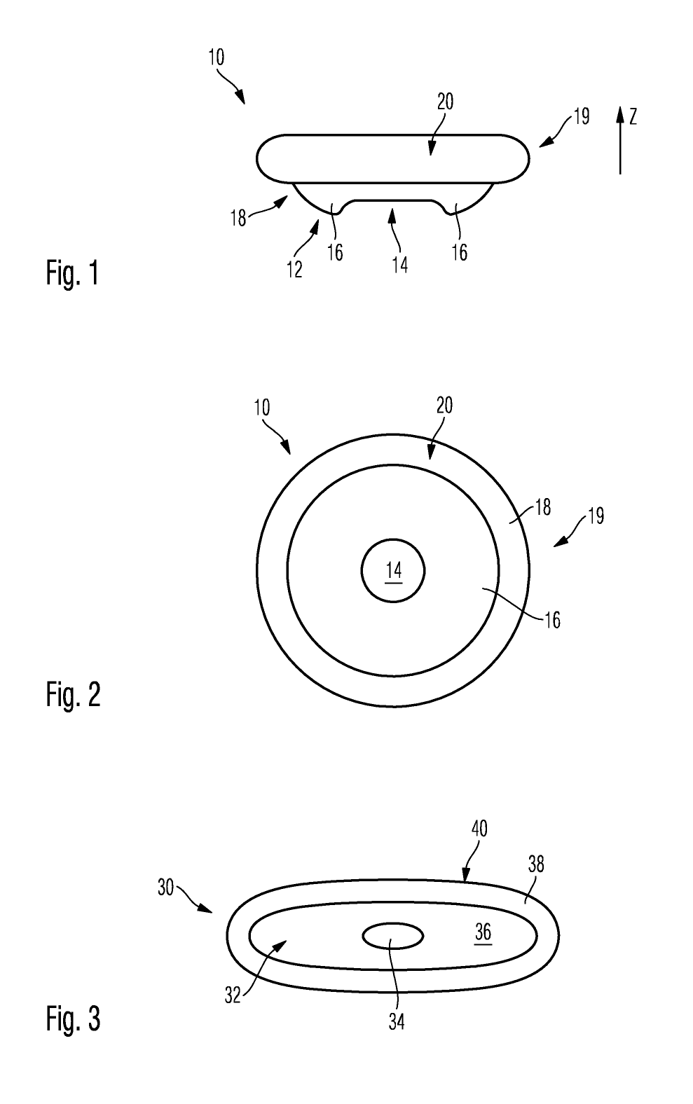

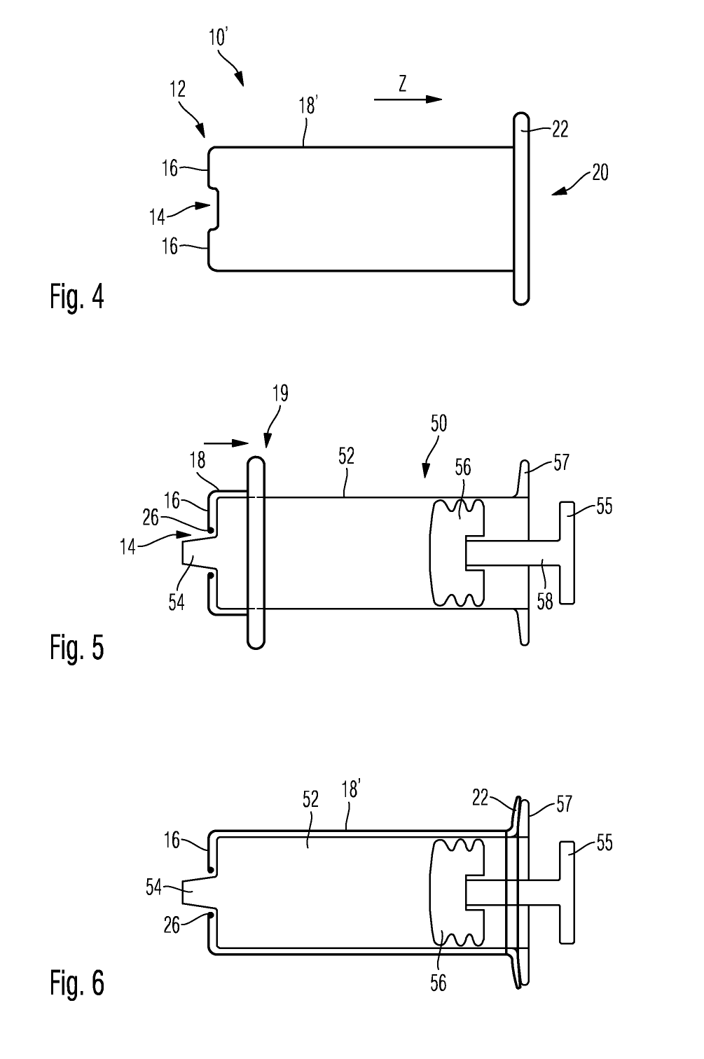

The light-protective cover 10 as shown in FIGS. 1, 2 and 4 to 6 comprises a bottom portion 12 having a bottom face 16 that features a centrally located through opening 14, through which a port structure 54 of a container 50 may extend. Apart from the through opening 14, the bottom face 16 is substantially closed and forms a bottom wall which gets in abutment with a corresponding bottom wall of a container 50 to be wrapped in the light-protective cover 10.

The bottom face 16 typically comprises a geometry that corresponds to the geometry and to the dimensions of the container 50. If the container 50 comprises a tubular shaped barrel 52 as illustrated in FIGS. 5 and 6, the bottom face 16 is typically of circular symmetric shape. With flat shape infusion bags 80 as shown for instance in FIGS. 9 and 10 the light-protective cover 60, in particular its bottom face 66 may comprise a somewhat elongated, substantially oval, elliptic or rectangular shape.

FIG. 3 for instance shows a light-protective cover 30 having an oval shaped bottom face 36 with an oval or circular shaped through opening 34.

The bottom portions 12, 32, in particular their bottom faces 16, 36 of light-protective covers 10, 30 are integrally formed with a tubular sidewall 18, 38. The radially inwardly extending bottom face 16, 36 merges into the adjacent sidewall 18, 38 which extends in axial direction (z). Since the material the light-protective cover 10, 30, 60, in particular its bottom face 16, 36, 66 and its sidewall 18, 38, 68 are made of, is mechanically stretchable, a tight fitting wrapping of a container 50, 80 can be attained by unfurling or unrolling the sidewall 18, 38, 68 along the side wall of the respective container 50, 80. The stretching and ductile properties of the light-protective cover 10, 30, 60 enable a universal adaptation of the cover 10, 30, 60 to a variety of different containers 50, 80.

Hence, in an initial configuration as illustrated in FIGS. 1 to 3 and 5, the light-protective cover 10, 30, 80 comprises a sidewall 18, 38, 68 which is curled to form an annular bulged portion 19 as shown in FIGS. 1, 2 and 5. In this initial configuration, the bottom face 16 extends across the annular rim 19 formed by the curled sidewall 18. The through opening 14 of the bottom face 16 is freely accessible, thereby allowing to insert a dispensing or discharging end of a container 50 through the curled receptacle 20, 40 of the cover 10, 30, and through its adjacently located bulged portion 19 to extend through the through opening 14 with a port structure 54 as shown in FIG. 5.

In this initial step of assembly, the bottom face 16 and the sidewall 18 are tightly adapted to the outer surface of the container 50. Then, by unfurling or unrolling the bulged portion 19, the sidewall 18′ of the cover 10 starts to expand in axial direction (z) thereby wrapping around the entire container 50, for instance around the entire barrel 52 of a syringe 50 as shown in FIGS. 5 and 6.

The barrel 52 is typically translucent and can be protected against electromagnetic radiation by means of the stretchable light-protective cover 10. The syringe 50 as shown in FIGS. 5 and 6 typically comprises a piston 56 slidably disposed in the inner volume of the barrel 52. The piston 56 is connected via a piston rod 58 with a laterally extending pressure piece 55, by way of which distally directed pressure can be exerted to the piston 56 for displacing the same towards the outlet port 54.

The syringe 50 as illustrated in FIGS. 5 and 6 further comprises a radially outwardly extending rim 57 at its proximal end which allows a user to apply a counter force to the barrel 52 during a dispensing action. Typically, the radially extending rim 57 serves as a support for index finger and middle finger of a user typically making use of his thumb to exert distally directed pressure to the pressure piece 55.

The sidewall 18′ of the unfurled light-protective cover 10′ comprises a reinforcing structure 52 at its free end opposite the bottom portion 12. The reinforcing structure 22 may comprise a structurally strengthened seam or edge. Additionally, and as indicated in FIGS. 5 and 6, also the oppositely disposed through opening 14 can be provided with a reinforcing seam 26 or welded structure.

As illustrated in FIG. 6, the reinforcing structure may axially abut with radially outwardly extending rim 57 at the proximal end of the barrel 52.

Alternatively, and due to its stretching capability, the sidewall 18′ may also be unfurled and stretched in such a way for not only covering a tubular portion of the barrel 52 of a container 50 but also to enclose the radially outwardly extending rim 57 of the barrel 52 provided at a proximal end thereof. Once, the free end of the light-protective cover 10′ has stretched or has been unfurled across the radially outwardly extending rim 57 in axial direction (z), the reinforcing structure 22 at the free end, hence, the reinforced seam 22 or a respective edge 22 may radially inwardly contract, thereby forming a quasi positive-interlock with the barrel 52.

On demand, the light-protective cover can be at least partially curled or rolled up in order to allow visual inspection of the container 50, 80. However, during unfurling and during assembly of the light-protective cover on the container 50, 80, the substantially closed bottom face 16 provides an axial abutment with the container 50, 80 and substantially fixes the bottom portion 12 of the light-protective cover 10 to a discharge end of the container 50, 80. The substantially tubular shaped receptacle 20 formed by the free end 22 and by the elongated and unfurled sidewall 18′ typically comprises an inner diameter which is slightly smaller than the corresponding diameter of the container 50, 80.

This way, unfurling of the light-protective cover always comes along with a certain stretching and tensioning of the material, the light-protective cover is made of. In this way, also cartridges to be inserted into medical delivery devices, such like infusion pumps can be universally wrapped with the present light-protective cover.

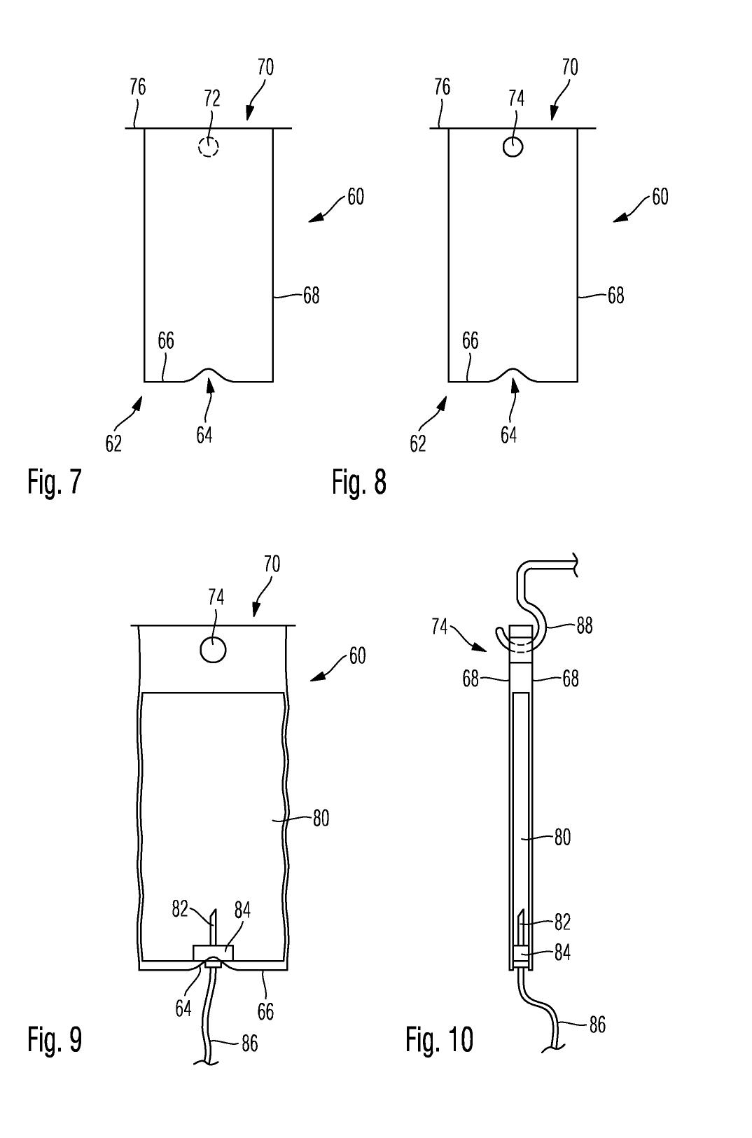

The light-protective cover 60 as shown in FIGS. 7 to 10 also comprises a bottom portion 62 featuring a through opening 64 in a bottom face 66. Also here, the bottom face 66 is integrally formed with a tubular shaped sidewall 68, which is to be curled in a similar way as described with the embodiment according to FIGS. 1 to 6. At its free and upper end, the sidewall 68 terminates with an annular shaped reinforcing structure 76. However, the upper end of the sidewall 68 opposite to the bottom face 66 is substantially open and provides a tubular shaped receptacle or opening 70.

The light-protective cover 60 as shown in FIGS. 7 to 10 is particularly adapted to receive and to wrap an elastic and deformable infusion bag 80 which is to be connected with an adapter 84 comprising a needle 82 and a discharge port 86, by way of which the content of the bag 80 can be provided e.g. to a patient.

Assembly of the light-protective cover 60 is to be conducted in a way similar as already described with regard to the embodiments according to FIGS. 1 to 6. Additionally, the light-protective cover 60 comprises a perforated structure 72 or a through opening 74 near its upper end. In its unfurled configuration the through opening 74 or the perforated structure 72 lies outside the area of the bag 80 disposed inside the cover 60. This way, the through opening 74 may serve as a hanger hole to hang the cover 60 on a hook 88 of an infusion stand for instance. Since the bottom face 66 is substantially closed, the infusion bag 80 cannot slip out of the hanging cover 60.

The perforated structure 72 as shown in FIG. 7 typically provides a predetermined breaking structure allowing to punch a through hole 74 through the sidewall 68 on demand.

Typically, the sidewall 68 comprises two mutually corresponding and overlapping through holes 74 or perforated structures 72 provided in diametrically opposite portions of the sidewall. This way, the cover 60 may be hooked on a hook 88 as shown in cross section in FIG. 10. In such hooked configuration, wherein two oppositely disposed sidewall portions are penetrated by the hook 88, the upper ends of oppositely disposed sidewall portions may get in close contact with each other and may effectively seal the rather large receptacle 70.

Additionally, since the sidewall 68 of the cover 60 tightly fits around the container 80, the upper protruding sidewall portions may inherently and effectively inhibit substantial ingress of electromagnetic radiation through the receptacle 70, especially when arranged on a hook 88.

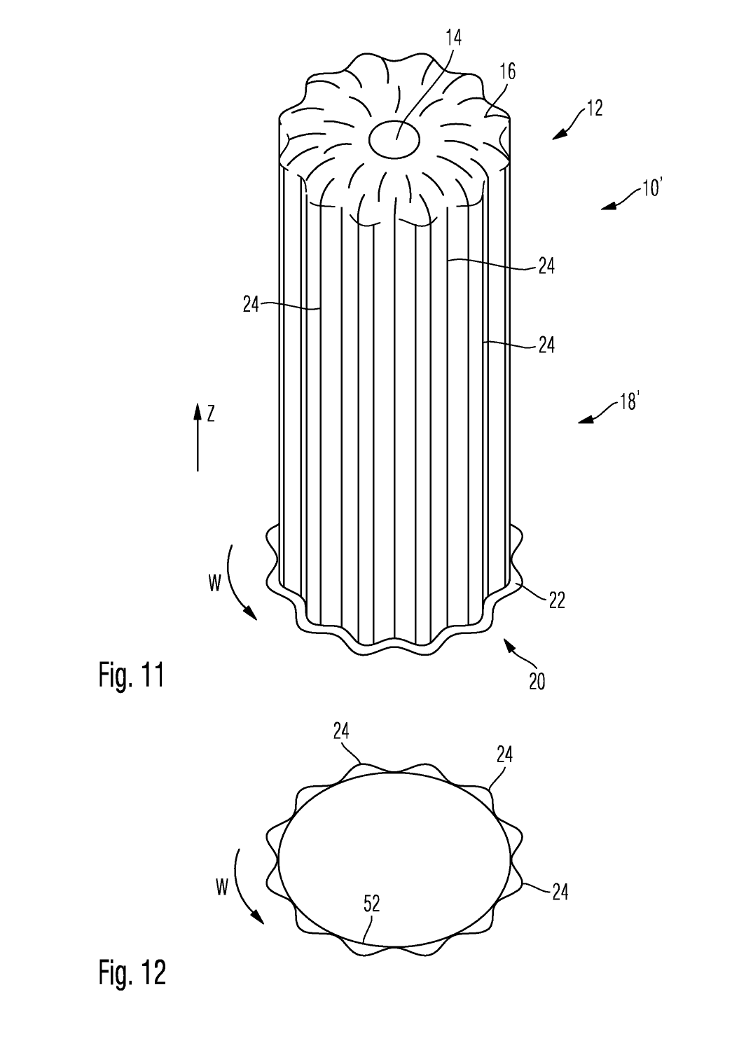

The light-protective cover 10′ as shown in FIGS. 11 and 12 in an upside down configuration further comprises an undulated sidewall 18′ having numerous undulations 24. As shown in FIG. 11, the undulations 24 extend in axial direction (z) and are equidistantly arranged along the circumference (w) of the tubular shaped sidewall 18′. By way of the undulations 24, the radial or lateral dimension of the light-protective cover 10′ may even more easily adapt to containers 50, 80 of variable size.

In the sketch of FIG. 12, a medium-sized barrel 52 of a syringe-type container 50 is illustrated. In this configuration, the undulations 24 of the unfurled sidewall 18′ are still present. However, when wrapping a barrel 52 of larger diameter, the undulations 24 will straighten out and the outer surface of the cover 10′ may get smoother.

Instead of providing the entire sidewall 18′ with an undulated structure, it is also conceivable to provide undulations only at predefined portions of the sidewall 18 and/or on the bottom face 16. Moreover, undulations may also extend in circumferential direction (w) so as to provide an increased flexibility and stretchability of the cover 10′ in axial direction.

Additionally, it is conceivable, that axially as well as circumferentially extending undulations are provided on bottom face 16 and/or on the sidewall 18. This way, the light-protective cover 10′ may smoothly be expanded across radially outwardly extending structures of the container 50, such like a radially extending rim 57 as shown in FIGS. 2 and 6.

1-12. (canceled)

13. A light-protective cover for a container accommodating a light-sensitive substance, the cover comprising:
a bottom face with at least one through opening to receive a port structure of the container,
a sidewall integrally formed with the bottom face and being adapted to at least partially enclose the container,
wherein the sidewall and/or the bottom face are made of a mechanically stretchable material being substantially opaque for electromagnetic radiation of a predefined spectral range and wherein the sidewall is unrollable or unfoldable from a curled initial configuration, in which the bottom face extends across an annular rim formed by the curled sidewall, into an extended configuration, in which it comprises a seamless tubular structure.

14. The light-protective cover according to claim 13, wherein the bottom face comprises a circular, oval or rectangular shape and wherein the sidewall extends substantially parallel to a surface normal of the bottom face.

15. The light-protective cover according to claim 13, wherein the sidewall comprises a free end facing away from the bottom face and forming an opening.

16. The light-protective cover according to claim 15, wherein the sidewall comprises at least one through opening which is arranged at a predetermined distance from the free end of the sidewall to provide a hanger structure.

17. The light-protective cover according to claim 16, wherein the sidewall comprises two diametrically opposed through openings.

18. The light-protective cover according to claim 15, wherein the free end and/or the at least one through opening of the sidewall comprise a reinforcing structure.

19. The light protective cover according to claim 13, wherein the bottom face and/or the sidewall at least in sections comprise at least one undulated structure.

20. The light-protective cover according to claim 19, wherein the sidewall comprises a plurality of undulated structures extending substantially parallel to each other in an axial (z) and/or in a circumferential direction (w).

21. The light-protective cover according to claim 13, wherein the material the bottom face and/or the sidewall are made of is selected from: synthetic rubber, butyl rubber, silicone, polyethylene, polyurethane and/or combinations thereof.

22. A container assembly comprising at least one container being at least partially filled with a light-sensitive substance and being wrapped in a light-protective cover according to claim 13.

23. The container assembly according to claim 22, wherein the container is filled with a liquid medicament.

24. A method of wrapping a container to accommodate a light-sensitive substance, the method comprising the steps of:
arranging a curled light-protective cover according to claim 13 near a discharge end of the container,
bringing the bottom face of the light-protective cover in abutment with an end face of the container and
unrolling the sidewall of the light-protective cover to wrap the container.
